(19) United States
(12) Patent Application Publication
(10) Pub. No.: US 2025/0299520 A1
(43) Pub. Date: Sep. 25, 2025

(54) SMART LOCK AND METHOD OF TRANSMITTING A STATUS OF A SMART LOCK

(71) Applicant: Glue AB, Stockholm (SE)

(72) Inventor: Edward King, London (GB)

(21) Appl. No.: 18/869,160

(22) PCT Filed: May 26, 2022
(86) PCT No.: PCT/EP2022/064363

§ 371 Date: Nov. 25, 2024

(51) Int. Cl. G07C 9/00

(52) U.S. Cl. CPC G07C 9/00174; G07C 2009/00642

(57) ABSTRACT

A smart lock is provided comprising: a drive train for actuating a lock mechanism between an unlocked position and a locked position; an electric actuator arranged to drive the drive train to actuate the lock mechanism; a manual actuator arranged to drive the drive train to actuate the lock mechanism; a sensor arranged to output a signal indicative of a status of the lock mechanism, the status representing whether the lock mechanism is in the unlocked position or the locked position; and a processor. The processor is configured to: receive the signal; encode the status and a timestamp into an information packet; and transmit the information packet independent of the presence of a receiver device.

### BACKGROUND

The present specification relates to a smart lock and method of transmitting a status of a smart lock.

A “smart” lock is an electromechanical lock which is designed to perform locking and unlocking operations on a door when it receives instructions from an authorized remote device, such as a smart phone, typically using a wireless protocol and a cryptographic key to execute the authorization process. The smart lock may also monitor access, or access attempts, and send alerts as necessary to the remote device. Smart locks may be used as a part of a smart home.

Smart locks are increasingly popular in smart/connected home environments, as well as in commercial property such as offices. The smart lock can be actuated between a locked position and an unlocked position either digitally via a command from a remote user device such as a smartphone, or via manual operation such as a handle or key.

As a part of this, it is necessary for the smart lock to transmit information regarding the status of the smart lock—whether it is in the locked position or the unlocked position.

When the smart lock is operated digitally, the remote user device either connects wirelessly directly to the smart lock, such as via Bluetooth Low Energy (BLE) or Thread, or it connects to a receiver device such as a smart hub which then connects to the smart lock itself via BLE. This connection to the receiver device may be via a platform such as a service provider's servers over the internet. The necessary command to perform the requested operation is then sent to the smart lock via BLE.

The decision of whether the smart lock is connected to directly by the remote device or via the hub is based on the remote device's proximity to the smart lock at the time of the operation. That is, if the remote device is in BLE range of the lock, it will connect (a local operation), and if not, the hub will be used (a remote operation).

In both cases, once the operation is complete, the status of the smart lock is transmitted. For example, this may be through the hub since it is always in BLE range of the smart lock.

When the smart lock is operated manually, one or more sensors may detect that the manual operation has occurred and, as with digital operations, the lock's status is then transmitted.

Currently, and as shown in FIG. 4, the hub must receive an advertising package from the smart lock and then respond to this advertising package to request the status of the smart lock.

In order to request the status of the smart lock, the hub needs to connect to the smart lock via BLE. This connection can last upward of five seconds if the connection environment is unfavourable, during which time no other devices can connect to the lock. Therefore, if a user happens to attempt a digital operation during this time it will be rejected because the smart lock is busy dealing with the status request from the hub.

Furthermore, if, for whatever reason, the hub cannot connect to the smart lock quickly to satisfy the status request, it will continue to attempt the connection periodically until it can, again reducing the availability of the lock for digital operations.

Additionally, if the hub is delayed in connecting to the smart lock and within that delayed period the user performs one or more subsequent operations, only the last operation status will be retrieved when the hub is eventually able to complete the status request. The smart lock status itself is not timestamped. Thus, if there is any doubt regarding the validity of the status, the only way of validating it is to review the smart lock's entire event log, which is timestamped. This entire event log can then be compared to the status to verify it. Again, this process can significantly reduce the availability of the smart lock for digital operations and moreover lead to ambiguity in the smart lock's event timeline.

Finally, with this method every lock operation, digital and manual, requires a corresponding status request to be satisfied in order to maintain the smart lock's timeline and status for the user. These requests use smart lock battery power that could otherwise be used for smart lock operations.

Furthermore, assuming since every smart lock performs the multiple operations per day, this necessarily results in many status requests each day being transmitted. This results in a lot of traffic for a service provider's platforms which can then slow the response of the smart lock.

There is therefore a need for an improved smart lock and method of transmitting a status of a smart lock.

### SUMMARY

A smart lock is provided, comprising: a drive train for actuating a lock mechanism between an unlocked position and a locked position; an electric actuator arranged to drive the drive train to actuate the lock mechanism; a manual actuator arranged to drive the drive train to actuate the lock mechanism; a sensor arranged to output a signal indicative of a status of the lock mechanism, the status representing whether the lock mechanism is in the unlocked position or the locked position; and a processor configured to: receive the signal; encode the status and a timestamp into an information packet; and transmit the information packet independent of the presence of a receiver device. The smart lock may be of any type, including a mortise lock or a rim lock or any other type of lock. The status of the lock mechanism may include the status of a bolt of the smart lock, a clutch in the lock mechanism or any other suitable component.

That is, the information packet is transmitted whether or not a receiver device (such as a hub) is present. In other words the transmission takes place regardless of the presence of a hub. Such a transmission may be referred to as a broadcast.

As a result there is no need for any connection procedure between the smart lock and a receiver device for the main status information transfer. This reduces the processing power required and hence the power usage. A simpler processor may also be used. Since smart locks are mounted on a moving door, and are typically retrofit, it can be difficult to provide a fixed power supply. Instead, most smart locks rely on battery power. By reducing the processing demand the battery life may be effectively extended.

This is particularly relevant in the context of a smart lock with manual and electric (or digital) actuation. The present invention transmits the status regardless of how the lock has been unlocked. For known smart locks if they are manually operated there is no indication that this has taken place. The present smart lock transmits the status via the information packet independently of the presence of a receiver hub. Thus correct information regarding the smart lock is always provided.

The information packet may be sent via a wired connection or wirelessly. A wireless transmission may be preferred as it can be difficult to reliably run wires to a smart lock which is mounted on a moving door.

The processor may be further configured to: determine whether a most recent operation of the smart lock was a digital operation or a manual operation, wherein the status further represents whether the most recent operation was a digital operation or a manual operation. This allows a complete record of the operations of the smart lock to be maintained.

The information packet may be a Bluetooth Low Energy advertising packet. This is an effective communications protocol for a smart lock, and the advertising packet is a feature of this protocol.

The processor may be further configured to encode a control object into the information packet. A control object allows further information to be included in the information packet, such as whether a receiver that receives the control object should connect to the smart lock to verify the lock status.

The control object may represent one or more of: that the smart lock has restarted; a state of charge of a battery of the smart lock; a security model of the smart lock; and/or a periodic signal (heartbeat signal). If there has been a recent restart of the smart lock the lock status may be incorrect and that re-synchronisation is needed. Likewise, the state of charge of the battery may be an indication that the battery has ran out of charge (i.e. is dead) and that replacement/charging of the battery is needed. The security model of the smart lock may be used to fork an implementation of an app on a remote device based on which security model the smart lock is running to allow the remote device to appropriately connect to the smart lock. The periodic signal, also known as a heartbeat signal, can be used to confirm that the smart lock is still reachable from the receiver device and therefore that a link between the smart lock and the receiver device is possible. If the periodic signal is not received, the receiver device can notify a user of a potential fault.

The processor may be configured to transmit the information packet periodically. This means that current information of the lock status is continuously relayed. By periodically it means that the information packet is transmitted at regular intervals.

The processor may be further configured to: determine whether the status has changed compared to a previous status; and if the status has changed transmit the information packet. In such an arrangement the information packet is only transmitted if there is a change in status and hence new information.

The processor may be configured to transmit the information packet until the smart lock receives confirmation that a receiver device has received the information packet. That is, absent any connection to a receiver device the smart lock can continue sending out the information packet. This allows the smart lock to ensure that the receiver device has received the status. This still transmits the status without a connection procedure. Alternatively, the smart lock may not be listening for a confirmation.

A system is provided comprising the smart lock disclosed above and a receiver device configured to: receive the information packet; decode the status from the information packet; and transmit the status to a remote device.

The receiver device may be further configured to: determine whether the status has changed compared to a previous status; and if the status has changed, transmit the status to the remote device. This reduces communication traffic between the receiver device and the remote device.

The receiver device may transmits the status to the remote device via a platform. This may be, for example, an internet-based platform which acts as an interface between the receiver device and the remote device.

A receiver device is provided configured to: receive the information packet; decode the status from the information packet; and transmit the status to a remote device. The remote device may be, for example, a remote user device such as a mobile phone. This may be transmitted via a platform such as a service provider's servers.

A computer-implemented method of transmitting a status of a lock mechanism of a smart lock representing whether the lock mechanism is in an unlocked position or a locked position is provided. The method comprising: receiving a signal indicative of the status from a sensor arranged to detect the status of the lock mechanism; encoding the status and a timestamp into an information packet; and transmitting the information packet independent of the presence of a receiver device.

This method has the benefits discussed above in relation to the smart lock.

The information packet may be a Bluetooth Low Energy advertising packet or a Thread packet. This is an effective communications protocol for a smart lock, and the advertising packet is a feature of this protocol.

The computer-implemented method may further comprise the step of: determining whether a most recent operation of the smart lock was a digital operation or a manual operation, wherein the status further represents whether the most recent operation was a digital operation or a manual operation. This allows a complete record of the operations of the smart lock to be maintained.

The information packet may be transmitted periodically. This means that current information of the lock status is continuously relayed. By periodically it means that the information packet is transmitted at regular intervals.

The computer-implemented method may further comprise the steps of: determining whether the status has changed compared to a previous status; and if the status has changed then transmitting the information packet. In such an arrangement the information packet is only transmitted if there is a change in status and hence new information.

The computer-implemented method may further comprise the steps of: receiving the information packet at a receiver device; decoding the status and the timestamp from the information packet; and transmitting the status to a remote device. The status may be transmitted to the remote device via a service provider's platform, for example via the internet. This transmits the lock status to a remote device-such as a user's smart phone—where the status may be read.

The computer-implemented method may further comprise the steps of: determining whether the status has changed compared to a previous status; and if the status has changed, transmitting the status to the remote device. This reduces communication traffic between the receiver device and the remote device.

A control object may further be encoded into the information packet; the control object may be decoded from the information packet, wherein the method may further comprise: if the control object indicates that the lock status may be unreliable then sending a request to the smart lock to confirm the lock status. A control object allows further information to be included in the information packet, such as whether a receiver that receives the control object should connect to the smart lock to verify the lock status.

The computer-implemented method may further comprise the steps of: receiving confirmation from a receiver device that the receiver device has received the information packet; and transmitting the information packet until the confirmation has been received. That is, absent any connection to a receiver device the smart lock can continue sending out the information packet. This allows the smart lock to ensure that the receiver device has received the status. This still transmits the status without a connection procedure. Alternatively, the smart lock may not be listening for a confirmation.

An alternative smart lock is provided, comprising: a sensor arranged to output a signal indicative of a status of a door, the status representing whether door is in an open position or a closed position; and a processor configured to: receive the signal; encode the status and a timestamp into an information packet; and transmit the information packet independent of the presence of a receiver device.

The smart lock may have any of the features disclosed in the present specification. There may also be a corresponding computer-implemented method. An exemplary sensor may be a light sensor which is covered when the door is closed, an accelerometer which detects a characteristic acceleration profile, or any other suitable sensor which can indicate a status of the door.

### BRIEF DESCRIPTION OF THE DRAWINGS

The present specification makes reference to the accompanying drawings, by way of example only, in which:

FIG. 1 shows a perspective view of a smart lock according to the present disclosure mounted to a door;

FIG. 2 shows an exploded view of the smart lock of FIG. 1;

FIG. 3 shows a cross-sectional view of the smart lock of FIG. 1;

FIG. 4 shows a process diagram for a previous method of transmitting a status of a smart lock; and

FIG. 5 shows a process diagram for a method of transmitting a status of a smart lock according to the present disclosure.

### DETAILED DESCRIPTION OF THE DRAWINGS

The present specification relates to smart lock 1 and a method of transmitting a status of a smart lock 1. Such smart locks may be applied to any type of closure or lock mechanism. An example of a Euro Cylinder smart lock is given in WO 2017/046399 A1, the entire contents of which is hereby incorporated by reference.

Further examples of smart locks are provided in WO 2021/156497 A1, WO 2021/156498 A1, WO 2022/018014 A1 and WO 2022/018015 A1, the entire contents of each of which is hereby incorporated by reference.

The hardware of the smart lock 1 of the present specification may generally correspond to any of the smart locks disclosed in one or more of these disclosures, or any other suitable smart lock. The present specification will refer to a door 6, which may generally be considered to be a domestic swing door 6. That is, a door 6 which is mounted on one or more hinges and pivots on these hinges between an open position and a closed position. However, the smart lock 1 may be used to secure other doors and other types of closure.

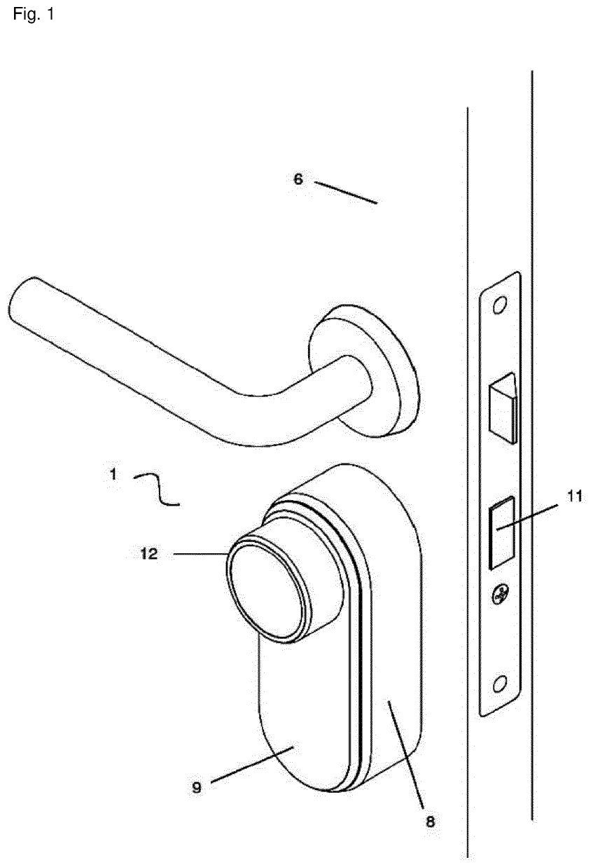

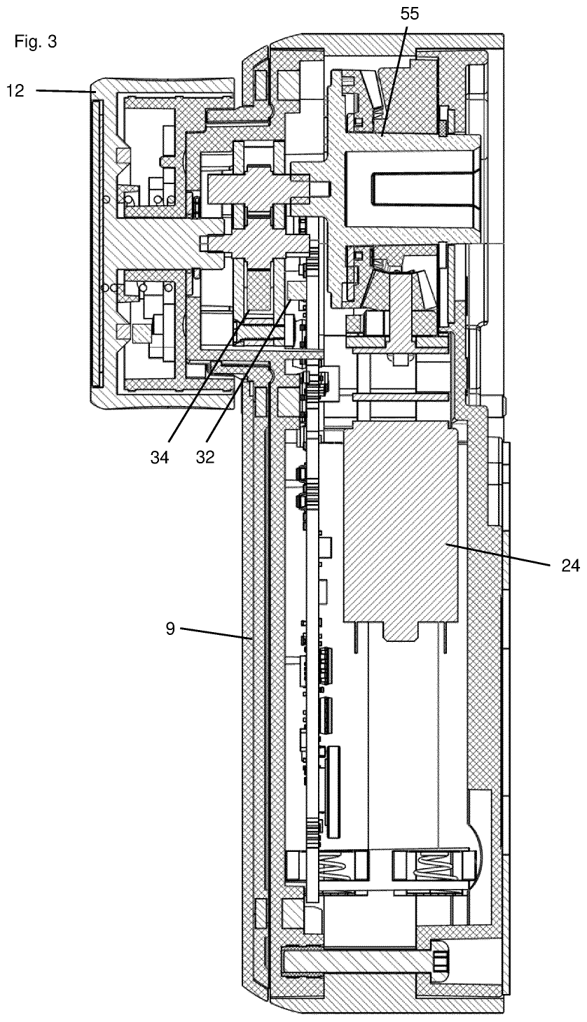

An example smart lock 1 which may be used as a part of the current specification is shown in FIGS. 1 to 3. The smart lock 1 may be formed of a main body component 8 and a front cover 9. Within this main body component 8, an electric actuator 24 may be provided. The electric actuator 24 may be a motor. The smart lock 1 may comprise a drive train for actuating a lock mechanism. The lock mechanism is actuated between an unlocked position and a locked position. In the locked position, the door 6 is prevented from opening. In the unlocked position the door 6 is able to open. In use, the electric actuator 24 drives the drive train in order to actuate the lock mechanism between the unlocked position and the locked position. In the locked position, the door 6 is prevented from opening. In the unlocked position the door 6 is able to open. In use, the electric actuator 24 drives the drive train in order to actuate the lock mechanism between the unlocked position and the locked position.

For example, an output shaft of the electric actuator 24 may be coupled to a pinion gear which is configured to couple to a bevel gear in the drive train. An axis of rotation of the output shaft of the electric actuator 24 may be transverse or perpendicular to a rotational axis of the bevel gear.

The lock mechanism may comprise a bolt. The bolt 11 may be moveable between an unlocked position where it generally does not protrude from the door 6 to a locked position where the bolt 11 protrudes from the door 6 to be received in a lock keep and prevent the door 6 from being opened. The position of the bolt 11 may be known as the “locking status”. The movement of the bolt 11 from the unlocked position to the locked position is known as a “locking action”. The movement of the bolt 11 from the locked position to the unlocked position is known as an “unlocking action”. A status of the lock mechanism may be whether the bolt 11 is in the locked position or the unlocked position.

The bolt 11, and/or lock mechanism as a whole, may be contained substantially within a recess in the door 6. This is particularly the case for a Euro Cylinder lock, or other mortice-type lock. Alternatively, the bolt, and/or lock mechanism as a whole, may be external to the door 6. For example, the bolt, and/or lock mechanism, may be retained within a separate housing, or within the smart lock 1 housing. This is particularly the case for a rim lock.

The smart lock 1 may comprise a receiver and/or a transmitter which is arranged for communication with a remote device, such as a smartphone. The smart lock 1 may also communicate with a receiver device such as a remote hub, such as a smart hub, which itself is in communication with the remote device.

The smart lock 1 may communicate with the remote device and/or the receiver device via any suitable communications protocol. Example protocols which may be suitable include Bluetooth Low Energy (BLE) or Thread. In general the communications protocol may use an information packet. The information packet is sent out as signal which can be detected by a remote device and/or a receiver device to connect to the smart lock 1.

In use, the receiver may receive an input signal from the remote device which initiates a locking action or an unlocking action. The smart lock 1 may further comprise a processor. The processor may be any suitable control system, and may include one or more sub-processors. The processor may receive the input signal and controls the actuation of the electric actuator 24 to drive the lock mechanism to complete the locking action or the unlocking action.

The smart lock 1 may further comprise one or more manual actuators. One manual actuator may be a key cylinder aligned with a keyhole for receiving a user's key to actuate the lock mechanism. The key cylinder may be a typical barrel cylinder which operates according to the known principles to rotate when the correct key is inserted into the keyhole and turned. A tail piece 105 extends from the key cylinder. The tail piece 105 turns when a key inserted into the key cylinder is turned. Movement of this tail piece 105 may actuate the lock mechanism to move the bolt 11 between the locked and unlocked positions. An alternative manual actuator may be a handle which is moved by a user to actuate the lock mechanism to move the bolt 11 between the locked and unlocked position.

Typically, the keyhole will be arranged on an outer side of the door 6. That is, the side of the door 6 which is generally exposed to the outer world. On the inner side of the door 6, it is not always necessary to require a key for locking and unlocking the smart lock 1. As an alternative, a thumb turn wheel or other manual actuator which does not include any verification means for the operator may be provided. This allows the interior manual actuator to be quickly and easily operated to move the bolt 11 between the locked and unlocked positions.

The smart lock may comprise one or more inputs to trigger a local digital operation of the smart lock. For example, the smart lock may comprise a button which when pressed triggers an operation of the smart lock. This is still a digital operation since the movement of the lock mechanism is not carried out by the user directly as in a manual operation.

In use, the actuation of the mechanical actuator also drives the drive train to actuate the lock mechanism. The drive train may include a clutch mechanism to isolate the mechanical and electric actuators 24. For example, the drive train may include a clutch body 55 which is arranged to receive the lock tail piece 105. The lock tail piece 105 may be received in an insert 25 which is selected to correspond to the particular type of lock being replaced.

Likewise, an appropriate mounting plate 26 may be provided to mount the smart lock 1 to the door 6. The mounting plate 26 may correspond to the particular type of lock. This insert 25 may then be received within the clutch body 55 to allow for actuation of the lock mechanism.

The smart lock 1 may further comprise a sensor. The sensor being arranged to output a signal indicative of a status of the lock mechanism. The status represents whether the lock mechanism is in the unlocked position or the locked position. The sensor may be any suitable sensor and may detect any component of the smart lock 1 which represents the status of the lock mechanism.

For example, the position of the drive train may be detected as this is directly linked to the position of the bolt 11 and hence the status of the lock mechanism. For such an arrangement, a position sensor may be provided. As the bolt 11 is driven by the drive train, knowing the position of the drive train allows you to know the position of the bolt 11 and hence its locking status. The position sensor may be arranged to output a location signal indicative of a position of the drive train, and hence of the lock mechanism and the bolt 11 and the electric actuator 24. For example, the position sensor may be arranged to detect the rotational position of one of the gears or clutch components in the drive train. The component which the position sensor is arranged on may be referred to as a sampling gear. In particular, the position sensor may be a rotary or linear encoder.

The position sensor may be a magnetic position sensor, formed of one or more magnets 34 and a magnetic sensor 32 arranged to detect the one or more magnets 34. In a particular embodiment, the magnetic position sensor may include a single diametric magnet 34, with a series of magnetic poles. The magnetic sensor may be a magneto-resistive or Hall Effect sensor.

The position sensor may be an active sensor, that is one that requires a power input to operate. This may be necessary to obtain sufficient accuracy from the measurement to determine the locking status of the lock mechanism. Once the location signal indicates that the lock has changed locking status, a signal may be transmitted to generate a notification on the user's remote device.

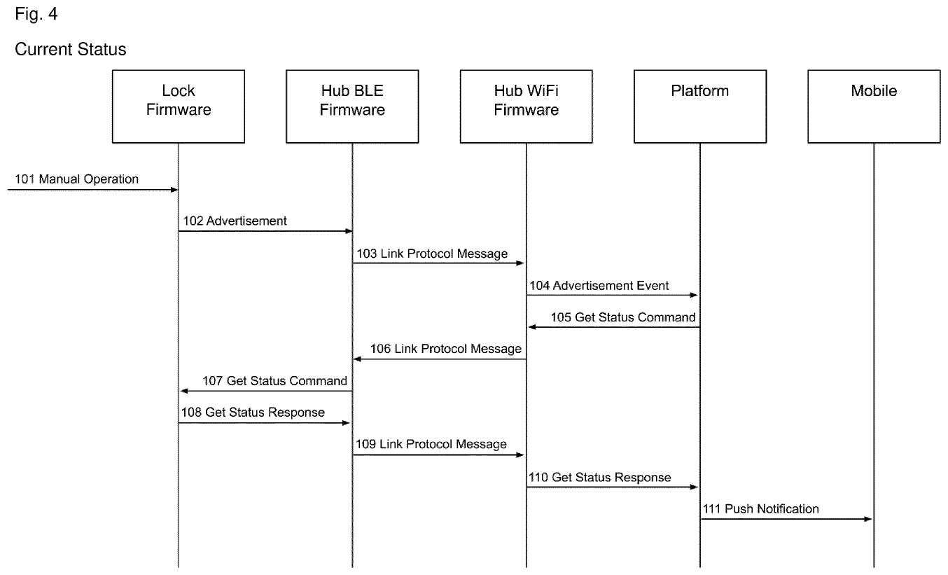

The previous method for generating a notification on a user's device is shown in FIG. 4, particularly for a manual operation 101. When the manual operation 101 takes place the smart lock 1 sends out an information packet 102. The receiver device-such as a smart hub-then receives the information packet 102. The receiver device then sends a link protocol message 103 to its receiver device transmitter, such as a Wi-Fi module. The receiver device then sends an advertisement event message to a platform such as a service provider's servers to inform the platform that the information packet 102 has been sent from the smart lock 1.

The platform then generates a get status command 105 which is sent to the receiver device, such as a receiver of a Wi-Fi module. The receiver of the receiver device then sends a link protocol message 106 to a transmitter of the receiver device which communicates with the smart lock 1. This transmitter then sends a get status command 107 to the smart lock 1. The smart lock 1 then provides a get status response 108 back to the receiver device. A link protocol message 109 is transmitted to the receiver device transmitter which communicates with the platform. A get status response 110 is sent to the platform. A notification, such as a push notification 111, is then sent to a remote user device such as a mobile phone.

As noted in the Background this method has a number of limitations. Particularly, digital operation of the smart lock 1 may be inhibited while the receiver device is attempting to connect to the smart lock 1 to send the get status command and receive the get status response.

The present disclosure takes this hardware and applies the following improvements. The smart lock 1 comprises a processor. The processor may be configured to receive the signal from the sensor indicative of a status of the lock mechanism-whether it is locked or unlocked. In alternatives, the status may be a status of the door-whether it is closed or open. The present disclosure may equally be applied to such a system with appropriate modifications thereto.

The processor of the smart lock 1 may be configured to encode the status of the lock mechanism (referred to as a “status byte”) along with a timestamp into an information packet. The information packet may be of any suitable format for the communications protocol of the smart lock 1. The status of the lock does not have to be explicitly in the information packet-a flag which is interpreted and/or information indicative of the status also effectively communicate the status of the smart lock 1.

The information packet is transmitted independently of any signal from a further device such as a receiver device. The information packet is transmitted from the smart lock 1 independent of the presence of a receiver device. That is, the information packet is transmitted from the smart lock 1 whether or not a receiver device is present, or regardless of the presence of a receiver device. In other words, there is no connection procedure before the information packet is transmitted. For example, there is no handshaking step which would be a part of such a connection procedure. Such a transmission may be referred to as a broadcast.

For example, the information packet may be transmitted periodically and/or after an event such as a change in the status of the lock has occurred.

Specifically, the information packet may be an advertising packet. For example, a Bluetooth Low Energy advertising packet. Any reference to information packet above and below may equally apply to such an advertising packet, where technically appropriate.

The information packet may be transmitted wirelessly from the smart lock 1, or via a wired connection. It may be preferred for the invention to be used with a wireless transmission.

The processor may further encode a control object (referred to as a “control byte”) into the information packet. The control object may indicate that the smart lock 1 has undergone an operation that means that the status of the lock mechanism may be unreliable. For example, the control object may indicate that the smart lock 1 has recently had a power cycle—i.e. been turned off and on again.

Further uses of the control object may include an indication of a state of charge of a battery of the smart lock 1 (i.e. whether the battery is dead); to indicate a security model in use; and/or as a periodic signal (heartbeat signal).

An example data structure for the information packet may be as follows:

| | | Control | Status |
|---|---|---|---|
| Description | Timestamp | Byte | Byte |
| Bytes | [0 . . . 3] | [4] | [5] |

Of course, the data structure may be varied in any suitable manner such as re-ordering the components.

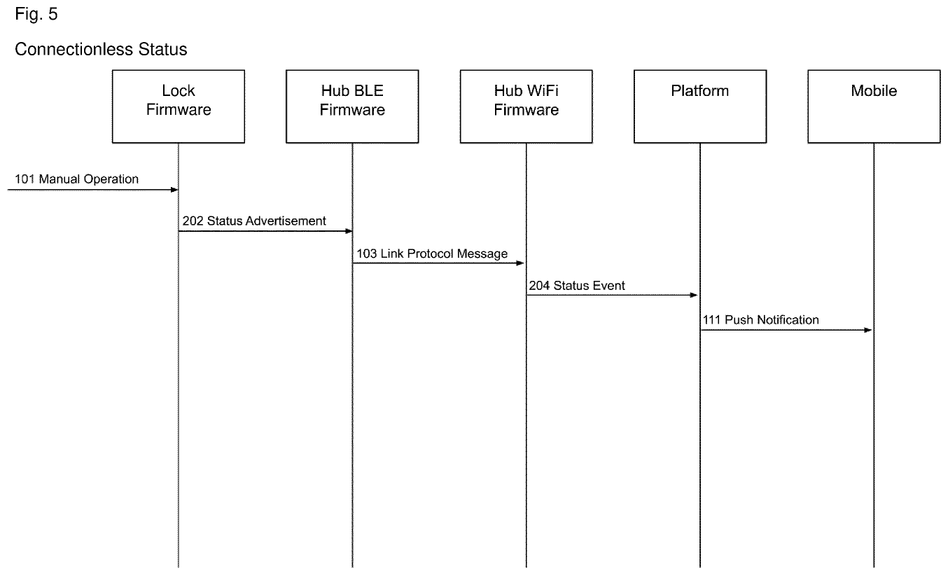

The connectionless method of FIG. 5 may then be used. Again, a manual operation 101 of the smart lock 1 is performed to lock or unlock the smart lock 1. This manual operation 101 is detected by the sensor of the smart lock 1. The signal is then received by the processor and encoded into the information packet as the status byte.

This encoded information packet is transmitted by the smart lock 1 as a status advertisement 202. The status advertisement is received by the receiver device—the smart hub. Particularly, the receiver device may comprise a receiver for receiving the information packet.

The processor may be configured to determine whether the status has changed compared to a previous status. That is, is the lock now unlocked and was previously locked, or vice-versa. If the status has changed, the processor may then transmit the information packet. If the status has not changed, the processor may not transmit the information packet.

The receiver device decodes the information packet to read the lock status. Specifically, the receiver device may comprise a receiver processor which decodes the lock status and the timestamp from the information packet.

A link protocol message 103 may then be transmitted to the receiver device transmitter, such as a Wi-Fi module.

The processor may be configured to transmit the information packet until the smart lock 1 receives confirmation that a receiver device has received the information packet. This may be a brief signal from the receiver device to the smart lock 1.

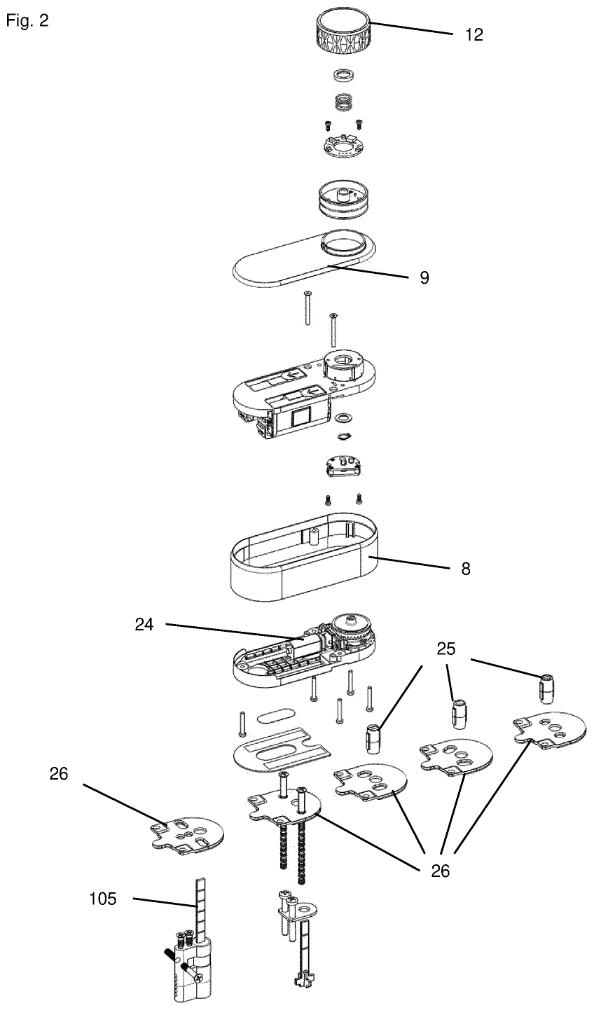

The receiver device then transmits the status to a remote device, such as a user's mobile phone. In the example of FIG. 2 this may be via a status event 204 transmitted to a platform such as a service provider's servers. The platform may then generate a notification, such as push notification 111, which is sent to the user's remote device.

In this sense, the receiver device does not have to connect to the smart lock 1 to determine the lock status. Instead, the relevant information is encoded in the information packet. As a result, all of the communication is in a single direction from the smart lock 1 to the remote user device. In other words, the information packet including the status is transmitted from the smart lock 1 independently of any signal from the receiver device.

During a manual operation the status of the lock may change a number of times, and may return back to the original status. For example, with a user leaving the house they may manually move the lock from the locked position, to the unlocked position, open the door 6, leave the house, close the door 6 and then manually move the lock from the locked position to the unlocked position. Such operations may be referred to as a toggle as the status byte will toggle between the statuses. With the timestamp the receiver device can place changes in the lock status in order and thereby remove duplications. For example in the operation noted above there would be a series of timestamps of increasing value with the status byte changing. The receiver processor may determine whether the status has changed compared to a previous status; and only transmit the status to a remote device if it has changed.

In examples which incorporate the control object this may be used to indicate to the receiver device that the status byte may be incorrect. For example, if the smart lock 1 was turned off or ran out of power and a manual operation was performed before the smart lock 1 was turned back on. If the smart lock 1 was unlocked while unpowered, the smart lock 1 may not have performed a sensing operation to detect this and hence the status byte may be incorrect. The fact that the smart lock 1 has recently restarted may be indicated in the control object. This may trigger the receiver device to communicate with the smart lock 1, such as via a get status command 107 to verify the status of the lock mechanism.

For example, the smart lock 1 may transmit successive information packets as a continuous data stream. The lock status byte will depend on the last change which has been detected. If the smart lock 1 has restarted then it is possible that this status may be incorrect. As a result, the receiver device must re-synchronise with the lock such as via status command 107.

Further uses of the control object may include an indication of a state of charge of a battery of the smart lock 1 (i.e. whether the battery is dead); to indicate a security model in use; and/or as a periodic signal (heartbeat signal). The control object, or any other part of the information packet, may comprise spare bits available for future information transfer as appropriate.

A system is also provided comprising the smart lock 1 and the receiver device.

A computer-implemented method of transmitting a status of a lock mechanism is therefore provided. Specifically the lock mechanism may be of a smart lock 1 which may have any of the features disclosed above.

The status represents whether the lock mechanism is in an unlocked position or a locked position. The first step of the method is receiving a signal indicative of the status from a sensor arranged to detect the status of the lock mechanism. This status is then encoded with a timestamp into an information packet. This packet may, for example, be an information packet. The information packet is then transmitted independent of the presence of a receiver device. An example receiver device may be a smart hub.

The status may further represent whether a change in the lock mechanism between the unlocked position and the locked position was via a digital operation or a manual operation.

This may be determined by the smart lock based on one or more sensors and/or context of the operation. For example, the smart lock (such as via the processor) may be configured to determine whether the most recent operation of the smart lock was a remote digital operation (e.g. via BLE from a recent connection), a local digital operation (e.g. pressing a button on the smart lock), or a manual operation (e.g. rotating the thumb turn wheel or using the key). For example, the smart lock will have a digital record if either a remote digital operation or local digital operation is commanded. If the lock status changes and neither have been commanded, it can be determined that the operation was a manual operation.

This transmission may be a short-range transmission such as Bluetooth Low Energy or Thread. Specifically, it may be at a shorter range than later transmissions from the receiver hub

The information packet may be received at a receiver device such as a smart hub. The status and timestamp may then be decoded from the information packet. The status may then be transmitted from the receiver device to a remote device such as a user's mobile phone. This transmission may be referred to as long-range transmission (with respect to the short-range transmission noted above) and may, for example, be via the internet.

The method may further comprise determining whether the status has changed compared to a previous status. The status may only be transmitted to the remote device if it has changed. This avoids transmitting status information regardless of whether a change has taken place.

In this sense an improved smart lock 1 and computer-implemented method of transmitting a status of a lock mechanism is provided.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules. Moreover, multiple method steps implemented in flowcharts contained herein, or as described above, may be implemented together by a single module.

It will be appreciated that, insofar as embodiments of the disclosure are implemented by a computer program, then a storage medium and a transmission medium carrying the computer program form aspects of the disclosure. The computer program may have one or more program instructions, or program code, that, when executed by a computer, causes an embodiment of the disclosure to be carried out. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

A method of manufacturing and/or operating any of the devices disclosed herein is also provided. The method may comprise steps of providing each of the features disclosed and/or configuring or using the respective feature for its stated function.

Please amend the claims according to the following listing of claims:

1. A smart lock comprising:
a drive train for actuating a lock mechanism between an unlocked position and a locked position;
an electric actuator arranged to drive the drive train to actuate the lock mechanism;
a manual actuator arranged to drive the drive train to actuate the lock mechanism;
a sensor arranged to output a signal indicative of a status of the lock mechanism, the status representing whether the lock mechanism is in the unlocked position or the locked position; and
a processor configured to:
receive the signal;
encode the status and a timestamp into an information packet; and
transmit the information packet independent of the presence of a receiver device.

2. The smart lock of claim 1, wherein the information packet is a Bluetooth Low Energy advertising packet or a Thread packet.

3. The smart lock of claim 1, wherein the processor is further configured to:
determine whether a most recent operation of the smart lock was a digital operation or a manual operation,
wherein the status further represents whether the most recent operation was a digital operation or a manual operation.

4. The smart lock of claim 1, wherein the processor is further configured to encode a control object into the information packet.

5. The smart lock of claim 4, wherein the control object represents one or more of:
that the smart lock has restarted;
a state of charge of a battery of the smart lock;
a security model of the smart lock; and/or
a periodic signal.

6. The smart lock of claim 1, wherein the processor is configured to transmit the information packet periodically.

7. A system comprising the smart lock of claim 1 and a receiver device configured to:
receive the information packet;
decode the status from the information packet; and
transmit the status to a remote device.

8. The system of claim 7, wherein the receiver device is further configured to:
determine whether the status has changed compared to a previous status; and
if the status has changed, transmit the status to the remote device.

9. The system of claim 7, wherein the receiver device transmits the status to the remote device via a platform.

10. A computer-implemented method of transmitting a status of a lock mechanism of a smart lock representing whether the lock mechanism is in an unlocked position or a locked position, the method comprising:
receiving a signal indicative of the status from a sensor arranged to detect the status of the lock mechanism;
encoding the status and a timestamp into an information packet; and
transmitting the information packet independent of the presence of a receiver device.

11. The computer-implemented method of claim 10, wherein the information packet is a Bluetooth Low Energy advertising packet or a Thread packet.

12. The computer-implemented method of claim 10, further comprising the step of:
determining whether a most recent operation of the smart lock was a digital operation or a manual operation,
wherein the status further represents whether the most recent operation was a digital operation or a manual operation.

13. The computer-implemented method of claim 10, wherein the information packet is transmitted periodically.

14. The computer-implemented method of claim 10, further comprising the steps of:
receiving the information packet at a receiver device;
decoding the status and the timestamp from the information packet; and
transmitting the status to a remote device.

15. The computer-implemented method of claim 14, further comprising the steps of:
determining whether the status has changed compared to a previous status; and
if the status has changed, transmitting the status to the remote device

16. The computer-implemented method of claim 10, wherein:
a control object is further encoded into the information packet;
the control object is decoded from the information packet,
wherein the method further comprises:
if the control object indicates that the status may be unreliable then sending a request to the smart lock to confirm the status.

17. The computer-implemented method of claim 10, further comprising the steps of:
receiving confirmation from a receiver device that the receiver device has received the information packet; and
transmitting the information packet until the confirmation has been received.
